(19) United States
(12) Patent Application Publication
(10) Pub. No.: US 2007/0182826 A1
(43) Pub. Date: Aug. 9, 2007

(54) Data access, resolution, and delivery method through the use of multi-bit digital icons

(75) Inventors: David E. Miller, Fairport, NY (US); Mark Corio, Hattiesburg, MS (US); Joseph Sutorius, Henrietta, NY (US)

Correspondence Address: MILLER, MATTHIAS & HULL, ONE NORTH FRANKLIN STREET, SUITE 2350, CHICAGO, IL, 60606, US

(73) Assignee: Knowledge Athletes, Inc., Fairport, NY (US)

(21) Appl. No.: 11/349,504

(22) Filed: Feb. 7, 2006

(51) Int. Cl. H04N 5/232

(52) U.S. Cl. 348/211.2

(57) ABSTRACT

A system and method for wirelessly retrieving information is disclosed. The system and method include a digital icon which is provided on a product or a printed publication or incorporated with printed or stenciled or other copy and which digitally encodes a captured image of the digital icon for transmission to a resolving host for the purpose of accessing and retrieving pertinent information relevant to the printed copy. A camera-enabled wireless electronic device can be used to capture an image of the digital icon and encoding software transmutes the digitally captured image into a value for transmission to a resolving host for the purpose of accessing and retrieving the pertinent information. If desired, a purchase of a product or service can be made through this system or the information can be accessed from an information source such as an Internet URL or other content or data source for the informational enhancement and enjoyment of the user.

### FIELD OF THE DISCLOSURE

The present disclosure generally relates to information, and more particularly relates to methods and apparatus for wirelessly retrieving information.

### BACKGROUND OF THE DISCLOSURE

Modern society is often referred to as the information age. Never before have consumers, students, workers and the like been able to access such a wealth of information. Not only is the information vast in its current form but it is also ever-evolving adding volumes of information on a daily if not hourly basis.

With the advent of the internet, consumers were immediately allowed access to product, company and institutional information in a manner which previously either was not available, or which would have taken much longer to retrieve by way of physical access, the post office or printed brochures. Users can now simply type in a website or universal resource locator (URL) address into a web browser and immediately be brought to the site and information of interest. Within that site, various pages are provided to provide detailed information in an organized fashion.

While the above is true, modern consumers are always looking to increase the speed with which the information is retrieved as well as access information most directly with little or no need for search engines and the like. Moreover, while the internet is a useful tool, it requires a portal, typically provided by way of a personal computer or laptop. The users often do not have access to such devices, or are inconvenienced by being required to carry them with themselves at all times.

It would according be advantageous to provide a new method and system for data retrieval which can even more efficiently streamline the ability of the user to access the information desired.

### SUMMARY OF THE DISCLOSURE

In accordance with one aspect of the disclosure, a method of retrieving information is disclosed which comprises photographing a digital icon using a wireless, camera-enabled electronic device, encoding the electronic image of the digital icon into a digital value, transmitting the value to a resolving host which resolves the digital value of the electronic image to a URL address which in turn can be used for information access on the Internet. The accessed information is then retrieved for display on the wireless, camera-enabled electronic device.

In accordance with another aspect of the disclosure, a digital icon is disclosed which is adapted to be captured by a camera-enabled device and used in the process of displaying downloaded information from an information/content source. The digital icon includes a digital border and a digital director. The digital border includes a mapped set of bits that identify the digital icon to the camera-enabled electronic device and its associated software. The digital director is a mapped set of bits that encodes the location of a resolving host that dynamically maps URL addresses to an identified set of digital icons.

In accordance with another aspect of the disclosure, a system for retrieving information is disclosed which comprises a plurality of digital icons, a camera-enabled electronic device, and software. Each digital icon is associated with at least one organization, company, good, or service, while the electronic device is adapted to capture an image of the digital icon. The software is operatively associated with the camera-enabled electronic device and adapted to encode a mapped set of bits of the digital icon into a value for transmission across a telecommunications medium to a resolving host that dynamically maps URL addresses to digital icon values that are stored on the resolving host. Information is thus dynamically linked and transmitted back to the camera-enabled electronic device from an information source.

In accordance with another aspect of the disclosure, a method of doing business is disclosed which comprises providing digital icons in printed publications, photographing a digital icon using a camera-enabled electronic device, encoding the electronic image of the digital icon into a value for transmission to a resolving host, dynamically mapping a URL address to a digital icon value that is stored on the resolving host, retrieving the requested information from a content provider/information source associated with the URL, displaying the information on the camera-enabled electronic device, and placing an order for goods or services or simply retrieving the requested content from an information source using the camera-enabled electronic device.

These and other aspects and features of the disclosure will become more readily apparent upon reading the following detailed description when taken into conjunction with the accompanying drawings.

### BRIEF DESCRIPTION OF THE DRAWINGS

FIG. 1 is a diagram schematically representing a system according to the teaching of the disclosure;

FIG. 2 is a flow chart depicting a sample set of steps which may be taken according to the method of the present disclosure; and

FIGS. 3a-c are plan views of digital icons according to the teachings of the disclosure.

While the present disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the disclosure as defined by the appended claims.

### DETAILED DESCRIPTION OF THE DISCLOSURE

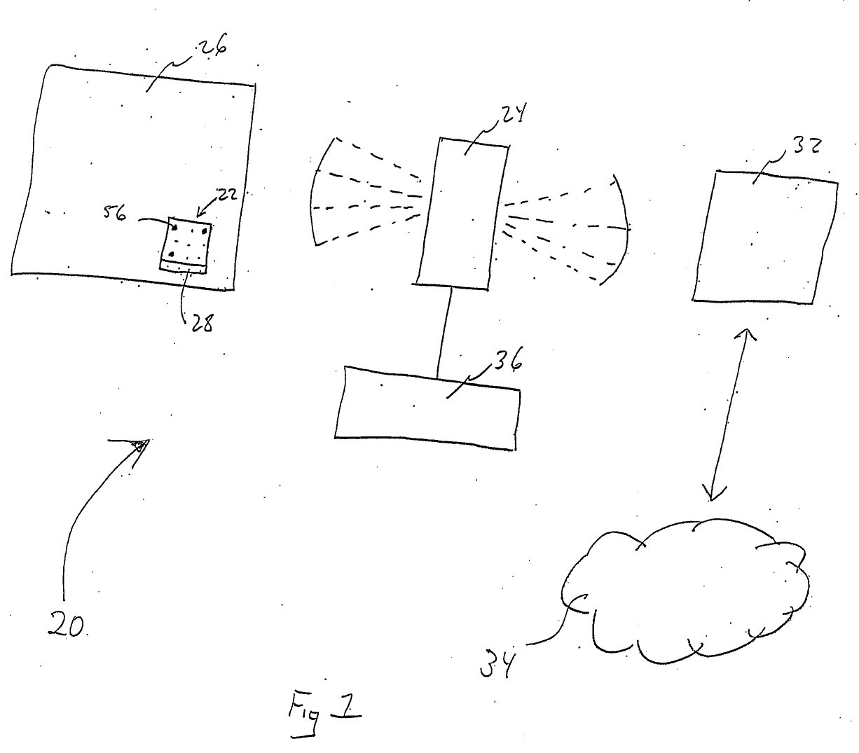

Referring now to the drawings, and with specific reference to FIG. 1, a system for retrieving information according to the teachings of the disclosure is generally referred to be reference numeral 20. While the following detailed description will be made with reference to a specific form of digital icon 22 using an electronic device 24, it is to be understood that the teachings of the disclosure can be used in any variety of additional systems to allow a user to access and retrieve information without the need of typing a URL address into a web browsing software package.

As shown in FIG. 1, the digital icon 22 can be provided within a printed publication 26. The printed publication 26 can be any number of different types of publications including, but not limited to, magazines, newspapers, brochures, business cards, bill boards, books, manuals, menus, leaflets, financial instruments, and the like. Moreover, the teachings of the disclosure can be used without the use of a printed publication 26 wherein the digital icon 22 is provided on any product shelf or positioned within various locations of a building, park, or facility.

The digital icon 22 contains a set of mapped bits that relate to an organization, company, good, service or other content that is discussed or related in some way to printed copy in a printed publication 26. A digital director 28 is another mapped set of bits embedded within the digital icon 22 that directs the encoded value of the captured digital icon image to a resolving host 32, which in turn links the information request to an information source such as an Internet URL or other source content 34. Moreover, rather than provide a particular website address which the user must write down and then remember to type into a web browser software package, the digital icon 22 can be captured by way of the camera-enabled electronic device 24 and automatically link the digital icon 22 to an information source or URL address 34. For example, in the depicted embodiment, the wireless camera-enabled electronic device 24 is provided in the form of a cell phone. However, it is to be understood that the device 24 could be provided in the form of a personal digital assistant, desktop computer, laptop computer, digital camera with Internet capability, or any other stationary, handheld, or portable data/telecom enabled device with built-in camera capability. Once the electronic device 24 captures the image of the digital icon 22, the electronic device 24 uses encoding software 36 to encode the digital icon 22 into an encoded value that can be transmitted for resolution to a resolving host 32. The resolving host 32 resolves the encoded value to a dynamically maintained URL or information source or other content or data source 34. The encoding software 36 can be loaded into the electronic device 24 where the electronic device 24 can simply capture the image of the digital icon 22 and then, once the captured image is transmuted to an encoded value with encoding software 36, the encoded value is transmitted to the resolving host 32 at which the encoded value is resolved to a dynamically maintained URL or information source or other content or data source 34. The information or other content stored in data source 34 is then downloaded, streamed, or otherwise transmitted to the camera-enabled electronic device 24 for use by the consumer. The consumer can in turn review the information, access related sites or other content, or if desired make purchases of products or services identified at data source 34.

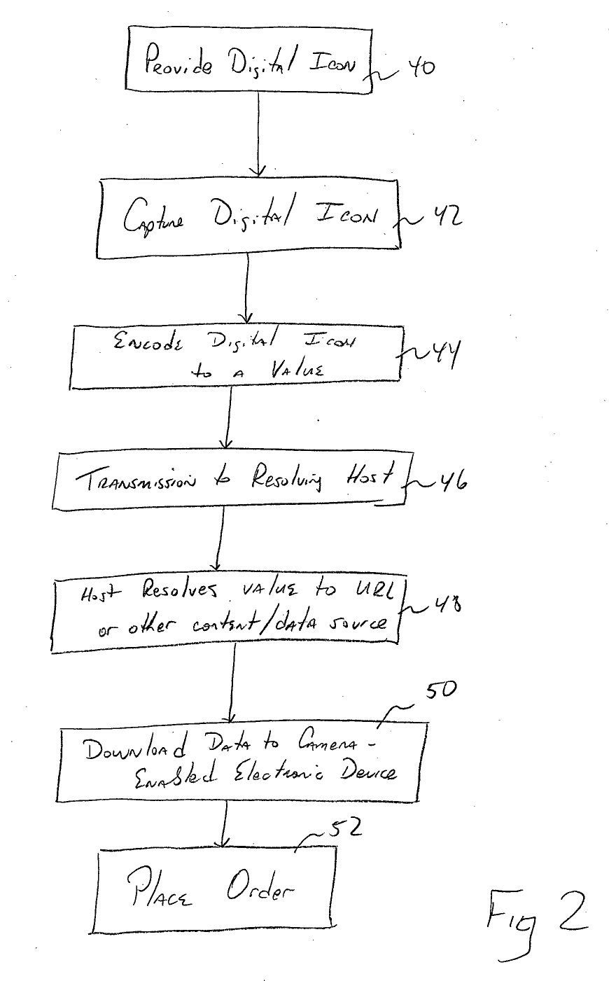

FIG. 2 depicts a sample set of steps which can be practiced by the method of retrieving information or business method identified by the current disclosure. As shown therein, a first step 40 may be for a manufacturer, service provider, organization, or company to purchase/lease a digital icon 22 within the printed publication 26 as identified by step 40. When a user reviews the printed publication and wishes to obtain further information or place an order/purchase for the described good or service, the digital icon 22 can be captured as a digital photograph by the camera-enabled electronic device 24 as indicated in step 42. As shown in step 44, the camera-enabled electronic device uses software 36 to encode the image captured by the camera-enabled electronic device 24 into a value. In step 46, the encoded value is transmitted to the resolving host 32, which resolves the encoded value to a data source, content source, or Internet URL, as depicted in step 48. Content, information, or other data is then downloaded, streamed, or otherwise transmitted to the camera-enabled electronic device 24, as depicted in step 50. The user then reviews the content or data or information in step 50 and if interested, can place an order as indicated in step 52. Encryption software can be used to ensure secure transmission of the request for information as well as the downloaded or streamed content or information.

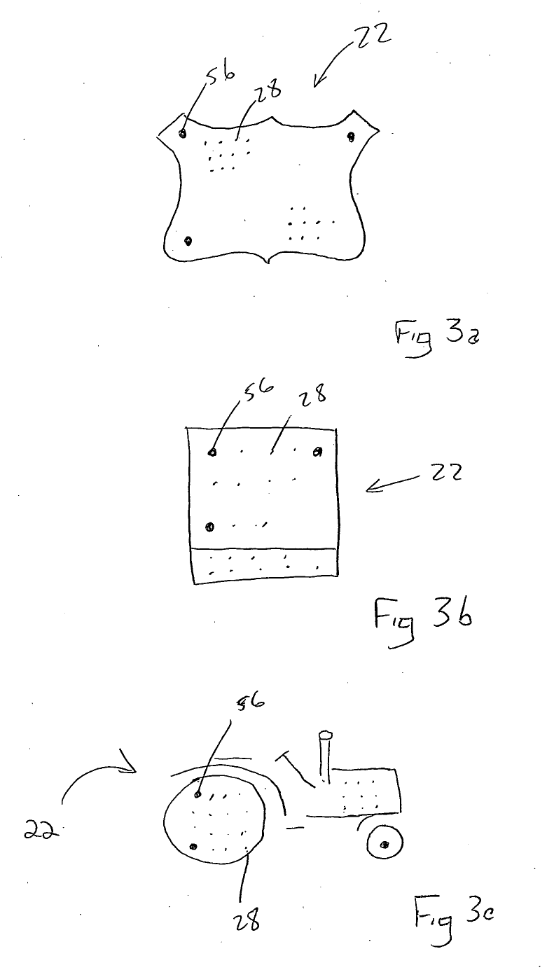

With reference to FIGS. 3a-c sample digital icons 22 is shown in detail. The digital icon 22 could be provided in any number of different forms, but in the depicted embodiments includes a digital border 56. The digital border 56 includes a mapped bit set of 16 bits, 32 bits, 64 bits, 128 bits, or so on. Upon using the camera-enabled electronic device 24 to capture the image of the digital icon 22 the digital border 56 immediately identifies the digital icon 22 as such and triggers activation of the encoding software 36.

The digital icon 22 may further include the digital director 28 which also may be a mapped set of 16, 32, 64, 128, 256, or so on bits of information to direct the encoded value to the resolving host 32, which in turn resolves encoded values to dynamically updated URLs or other content or data sources.

After the camera-enabled electronic device 24 captures an image of a digital icon 22, the captured image is converted to an encoded value and this value includes certificated authentication service. In addition, the certificated authentication services and/or the encoding software 36 provide content filtering based on an image capture comparison to a stored set of rules.

In one embodiment, the digital icon 22 can be provided with RFID capability such that the camera-enabled electronic device 24 need not capture the image of the digital icon 22 with its camera, but instead the camera-enabled electronic device is fitted with short-range RF transceiver capability to interact with the RFID tag, and the camera-enabled electronic device 24 then encodes the signal from the RFID tag into a value for transmission to the resolving host 32 which in turn resolves the encoded value to a dynamically updated URL or other content or data source for information transmission back to the camera-enabled electronic device 24. For example, if a user were to visit a museum or store site, or even pass a road sign along a highway or historic site at a scenic overlook, if such an RFID tag is provided at the item visited or being viewed, the camera-enabled electronic device 24 with built-in RF transceiver capability to interact with RFID tags can automatically identify and communicate with said RFID tag with the purpose of accessing and retrieving content from a remote information source for replay or presentation on the camera-enabled electronic device 24.

In another embodiment, an electronic image can be captured using a wireless, camera-enabled electronic device, and that image can be transmitted as an image or an encrypted image to a resolving host that contains a reference library of images. Each image can in turn be resolved to a URL address or other relevant file location or data source for information access and retrieval.

With such an embodiment a business method component would be the selling of subscriptions to organizations who could, for a fee, add one or more images of their trademarks or other identifying indicia, to the resolving hose database. For example, if an organization had thirteen trademarks that it used in the marketplace, and ten of the trademarks were for marketing and sales purposes identifiable as specific brands, then the organization would subscribe to have those ten trademarks added as images to the resolving host. For each image subscribed and hosted on the resolving host, every time the image is captured by a user in the marketplace using a wireless, camera-enabled electronic device, the captured image can be transmitted to the resolving host and the transmitted image can then be resolved to a data source such as an Internet URL or other data source. The user could then obtain additional information, place an order, request follow-up from the organization, and the like.

In still another embodiment, the digital icon 22 can be provided as a trademarked or other icon without digital components, but the captured digital image in conjunction with the encoding software 36 recognize the trademarked or other icon without an embedded digital component or embedded RFID tag. The captured image is then transmitted to an encoded value for transmission to a resolving host 32, which in turn resolves the encoded value to a dynamically updated URL or other contact or data source 34 for information transmission back to the camera-enabled electronic device 24 or other display device. For example, if the user were to visit a retail store and find an item of interest, the user could digitally capture a trademarked image or other image registered with the resolving host 32 and identified as a registered image and the captured image would be transmitted to an encoded value and transmitted to the resolving host 32. The resolving host 32 would then resolve the encoded value to a data source, content source, or Internet URL, and the content would be downloaded or streamed to the camera enabled electronic device 24, or other display as depicted in step 50 of FIG. 2. The user can then review the content or data or information of step 50, and then, if interested, make additional information requests or place an order as indicated in step 52 of FIG. 2.

From the foregoing, it can be understood that the pending disclosure provides a system and method for a user to wirelessly access information by way of the internet simply by capturing the image of a digital icon provided on the product in a printed publication, or the like. Accordingly, the user need not type a URL address into a web browsing software package as is conventional, but simply upon taking a picture of the icon retrieve the desired information.

What is claimed is:

1. A method of retrieving information, comprising the electronic capture or digital photo capture of a digital icon using a wireless, camera-enabled electronic device, comprising:
transmuting the captured digital image into an encoded value for transmission to a resolving host;
resolving the encoded value to an Internet URL; and
transmitting the accessed content or information from the Internet URL to the camera-enabled electronic device.

2. The method of claim 1, wherein the wireless camera-enabled electronic device is a cell phone.

3. The method of claim 1, wherein the wireless camera-enabled electronic device is a personal digital assistant.

4. The method of claim 1, wherein the digital icon is provided on a printed publication.

5. A digital icon adapted to be captured by a camera-enabled electronic device, the digital icon being used to encode specific elements about at least one of a product, service, and organization, into an encoded value for transmission to a resolving host with the purpose of retrieving content on a remote information host, and comprising:
a digital border identifiable by the camera-enabled electronic device, the digital border being a mapped set of bits that specifically identifies at least one of an organization, a product, and a service; and
a digital director identifiable by the software associated with the camera-enabled electronic device, the digital director being a mapped set of bits used to direct an encoded value to a resolving host.

6. The digital icon of claim 5, wherein the digital border and digital director each include between 16 and 256 bits.

7. The digital icon of claim 5, further including certificated authentification services.

8. The digital icon of claim 5, further including RFID tag capability.

9. A system for retrieving information, comprising:
a plurality of digital icons, each digital icon being associated with at least one of an organization, a product, and a service;
a camera-enabled electronic device adapted to capture an image of the digital icon;
software operatively associated with the camera-enabled electronic device adapted to:
identify the digital border and the digital director;
encode the digital icon into an encoded value for transmission to a resolving host; and
recognize information encoded in a specific set of RFID tags which specifically identify at least one of an organization, a product, and a service and encode information from the RFID tag into an encoded value for transmission to a resolving host.

10. The system of claim 9, wherein the software includes encryption software capability.

11. The system of claim 9, further including a database of digital icons stored in memory for later encoding and transmission to a resolving host for information access and retrieval from a data source such as an Internet URL or other content or data source.

12. A method of doing business, comprising:
providing a digital icon in a printed publication;
digitally capturing the digital icon using a camera-enabled electronic device;
encoding the captured image by using the software for transmission to a resolving host with the intent to access and retrieve content and information from a remote data source.
displaying the retrieved content on the camera-enabled electronic device; and
placing an order for at least one of goods and services displayed on the camera-enabled electronic device using the camera-enabled electronic device.

13. The method of claim 12, wherein the camera-enabled electronic device is a cell phone.

14. The method of claim 12, wherein the camera-enabled electronic device is a personal digital assistant.

15. The method of claim 12, wherein the printed publication is a magazine.

16. The method of claim 12, wherein the printed publication is an advertisement.

17. The method of claim 12, wherein the printed publication is a newspaper.

18. The method of claim 12, wherein the printed publication is a book.

19. The method of claim 12, wherein the printed publication is a map.

20. The method of claim 12, wherein the printed publication is a product label.
